(19) United States
(12) Patent Application Publication
(10) Pub. No.: US 2025/0307559 A1
(43) Pub. Date: Oct. 2, 2025

(54) HIERARCHICALLY GUIDED DATA AUGMENTATION FOR IMPROVING HIGHER LEVEL REASONING ABOUT IMAGES WITH LLMS

(71) Applicant: SRI International, Menlo Park, CA (US)

(72) Inventors: Karan SIKKA, Robbinsville, NJ (US); Michael COGSWELL, Yardley, PA (US); Yunye GONG, West Windsor, NJ (US); Ajay DIVAKARAN, Monmouth Junction, NJ (US)

(21) Appl. No.: 19/092,665

(22) Filed: Mar. 27, 2025

Related U.S. Application Data
(60) Provisional application No. 63/571,902, filed on Mar. 29, 2024.

(51) Int. Cl. G06F 40/30; G06F 16/242

(52) U.S. Cl. CPC G06F 40/30; G06F 16/243

(57) ABSTRACT

A method, apparatus and system for determining question-answer pairs for finetuning a language model includes, for at least two layers of a hierarchical taxonomy having at least two layers including respective words resulting in layers of varying complexity, determining a set of words associated with a layer of the hierarchical taxonomy, and determining at least one question-answer pair intended to increase a semantic understanding of content based on a question generated using at least one word of the set of words and the content to which the question-answer pair is applied. A language model can then be finetuned using the determined question-answer pairs.

### CROSS-REFERENCE TO RELATED APPLICATION

This application claims benefit of and priority to U.S. Provisional Patent Application Ser. No. 63/571,902, filed Mar. 29, 2024, which is herein incorporated by reference in its entirety.

### FIELD

Embodiments of the present principles generally relate to improving the accuracy of language models and, more particularly, to a method, apparatus and system for improving the higher-level reasoning performance of Large Language Model based systems using hierarchically guided data augmentation.

### BACKGROUND

Content understanding today consists of answering questions about the content with no regard to the difficulty of the questions or any other relationship between the questions. The state of the art consists of systems that use neural networks to memorize answers to questions. For example, a Visual question answering (VQA) system assumes the task of answering questions based on an image or video. The approaches to VQA are largely statistical, with no notion of relative difficulty of questions. GQA systems include datasets that include categorization by semantics (query, verify, logical, choose, compare) and structures (global, attribute, object, relation, category). Such categorization, however, is based on underlying scene graphs and are not grounded in a scientific definition of comprehension.

Specifically, Large Language Models (LLMs), such as ChatGPT, give good answers to many questions but often give wildly inaccurate answers, often called hallucinations. Hallucinations in LLMs can be attributed to gaps in the semantic understanding of content of the LLMs. Training such models is very expensive, and often such models are closed and proprietary, so retraining such models is not a viable option. Such situations present a problem to the general applications developer since the developers do not have open access to such models. Currently, the problem is addressed only through retraining of models by the proprietors.

### SUMMARY

Embodiments of the present principles provide methods, apparatuses and systems for implementing a hierarchical knowledge taxonomy, including question-answer pairs, for fine tuning language models for improving the higher-level reasoning performance of the language models.

In some embodiments a method for determining question-answer pairs and finetuning a language model includes, for at least two layers of a hierarchical taxonomy having at least two layers including respective words resulting in layers of varying complexity, determining a set of words associated with a layer of the hierarchical taxonomy, and determining at least one question-answer pair intended to increase a semantic understanding of content based on a question generated using at least one word of the set of words and the content to which the question-answer pair is applied; and finetuning the language model using the determined question-answer pairs.

In some embodiments, an apparatus for determining question-answer pairs and finetuning a language model includes a processor and a memory coupled to the processor, the memory having stored therein at least one of programs or instructions. In some embodiments, when the processor executes the programs or instructions, the apparatus is configured to, for at least two layers of a hierarchical taxonomy having at least two layers including respective words resulting in layers of varying complexity, determine a set of words associated with a layer of the hierarchical taxonomy, determine at least one question-answer pair intended to increase a semantic understanding of content based on a question generated using at least one word of the set of words and the content to which the question-answer pair is applied, and finetune the language model using the determined question-answer pairs.

In some embodiments a system for determining question-answer pairs and finetuning a language model includes a language model and an apparatus including a processor and a memory coupled to the processor, the memory having stored therein at least one of programs or instructions. In some embodiments, when the processor executes the programs or instructions, the apparatus is configured to, for at least two layers of a hierarchical taxonomy having at least two layers including respective words resulting in layers of varying complexity, determine a set of words associated with a layer of the hierarchical taxonomy, determine at least one question-answer pair intended to increase a semantic understanding of content based on a question generated using at least one word of the set of words and the content to which the question-answer pair is applied, and finetune the language model using the determined question-answer pairs.

Other and further embodiments in accordance with the present principles are described below.

### BRIEF DESCRIPTION OF THE DRAWINGS

So that the manner in which the above recited features of the present principles can be understood in detail, a more particular description of the principles, briefly summarized above, may be had by reference to embodiments, some of which are illustrated in the appended drawings. It is to be noted, however, that the appended drawings illustrate only typical embodiments in accordance with the present principles and are therefore not to be considered limiting of its scope, for the principles may admit to other equally effective embodiments.

FIG. 1 depicts a high-level block diagram of a data generation and training system in accordance with an embodiment of the present principles.

FIG. 2 depicts a graphical representation of an exemplary hierarchical taxonomy that can be implemented by a data generation and training system of the present principles in accordance with an embodiment of the present principles.

FIG. 3 depicts two examples of content that can be received and processed by a data generation and training system of the present principles as applied to a first layer, a remember layer, of the hierarchical taxonomy of the embodiment of FIG. 2 in accordance with an embodiment of the preset principles.

FIG. 4 depicts a functional diagram of components of the data generation and training system of FIG. 1 as applied to a first layer of the hierarchical taxonomy in accordance with an embodiment of the present principles.

FIG. 5 depicts verbs associated with the second layer, the understand layer, of the hierarchical taxonomy of FIG. 2 in accordance with an embodiment of the preset principles.

FIG. 6 depicts the verbs associated with the third layer, the apply layer, of the hierarchical taxonomy of FIG. 2, in accordance with an embodiment of the preset principles.

FIG. 7 depicts the verbs associated with the fourth layer, the analyze layer, of the hierarchical taxonomy of FIG. 2, in accordance with an embodiment of the preset principles.

FIG. 8 depicts the verbs associated with the fifth layer, the evaluate layer, of the hierarchical taxonomy of FIG. 2, in accordance with an embodiment of the preset principles.

FIG. 9 depicts the verbs associated with the sixth layer, the create layer, of the hierarchical taxonomy of FIG. 2, in accordance with an embodiment of the preset principles.

FIG. 10 depicts a Table of example question-answer pairs determined for content associated with various datasets and intended to increase at least the context of the content in accordance with at least one embodiment of the present principles.

FIG. 11A depicts a Table of example question-answer pairs intended to increase the context and specifically increase the semantic understanding of the image content in accordance with at least one embodiment of the present principles.

FIG. 11B depicts a Table including counter-factual/negative question-answer pairs intended to increase the context and specifically increase the semantic understanding of content of the image of FIG. 11A in accordance with at least one embodiment of the present principles.

FIG. 12 depicts a graphical representation of an embedding process in accordance with an embodiment of the preset principles.

FIG. 13 depicts a process for determining an adapted model of a model determined from the embedding process of FIG. 12 in accordance with an embodiment of the present principles.

FIG. 14 depicts a graphical representation of an adaptation of a model determined for a list of ingredients for making pancakes to a list of ingredients for making crepes including logical rules in accordance with an embodiment of the present principles.

FIG. 15 depicts a flow diagram of a method for determining question-answer pairs and finetuning a language model in accordance with an embodiment of the present principles.

FIG. 16 depicts a computing device suitable for use with embodiments of a data generation and training system in accordance with the present principles

FIG. 17 depicts a high-level block diagram of a network in which embodiments of a data generation and training system in accordance with the present principles, can be applied.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present principles generally relate to methods, apparatuses and systems for providing hierarchically guided data augmentation for, for example, improving the higher-level reasoning performance of language model-based systems, such as Large Language Model-based systems, via finetuning of the language model. While the concepts of the present principles are susceptible to various modifications and alternative forms, specific embodiments thereof are shown by way of example in the drawings and are described in detail below. It should be understood that there is no intent to limit the concepts of the present principles to the particular forms disclosed. On the contrary, the intent is to cover all modifications, equivalents, and alternatives consistent with the present principles and the appended claims. For example, although embodiments of the present principles will be described primarily with respect to a specific hierarchical knowledge representation and associated content, such as the Bloom's Taxonomy, such teachings should not be considered limiting. Embodiments in accordance with the present principles can function with substantially any content and can include other, not described, hierarchies.

Embodiments of the present principles are provided to improve the higher-level reasoning performance of language model-based systems, such as Large Language Model-based systems, through semantic expansion of context using hierarchical guidance. In some embodiments, hierarchies, such as Bloom's hierarchy, are used to create prompts that set up higher level reasoning questions such as “what if”, “Summarize the text,” etc. to generate a number of higher-level reasoning question and answer pairs. In some embodiments, such hierarchical expansion is used to go depth first into content, such as a single image, rather than ask the same question of multiple images. In some embodiments, the resulting question-answer pairs of the present principles can be used to augment the training data of a Large Language Model (LLM) through instruction tuning. That is, in some embodiments the additional data generated in accordance with the present principles can be used to fine tune a frozen LLM backbone such that the LLM is not completely retrained. Such fine-tuning of the present principles leads to removal of common hallucinations in the LLM answers as well as improvement in accuracy of answers to higher-level reasoning related questions.

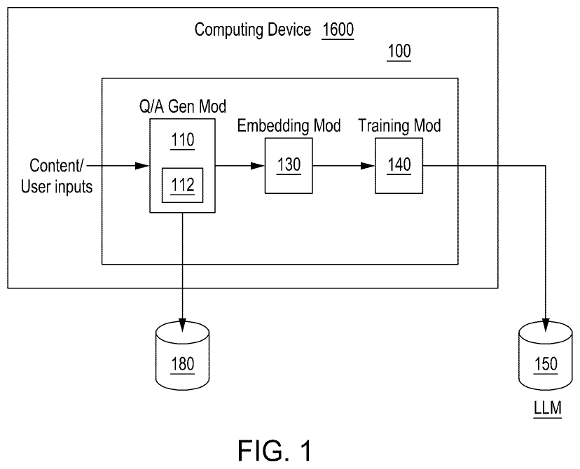

FIG. 1 depicts a high-level block diagram of a data generation and training system 100 in accordance with an embodiment of the present principles. The data generation and training system 100 of FIG. 1 illustratively comprises a question/answer generation module 110, an optional embedding module 130, a training module 140, and a storage device 180. FIG. 1 further depicts a language model, illustratively a Large Language Model (LLM) 150.

As further depicted in FIG. 1, embodiments of a data generation and training system of the present principles, such as the data generation and training system 100 of FIG. 1, can be implemented via a computing device 1600 in accordance with the present principles (described in greater detail below).

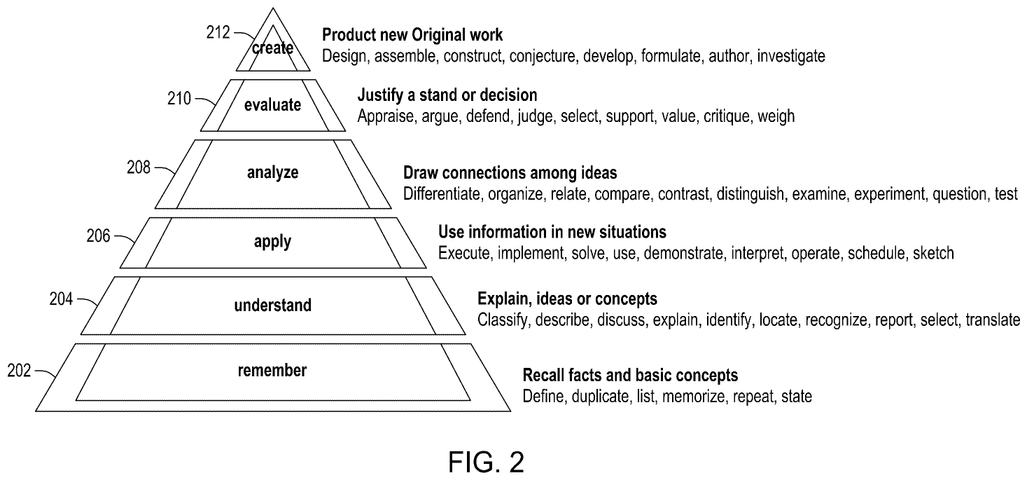

FIG. 2 depicts a high-level diagram of an exemplary hierarchical representation/taxonomy 200 that can be implemented by a data generation and training system of the present principles, such as the data generation and training system 100 of FIG. 1, in accordance with an embodiment of the present principles. The hierarchical taxonomy 200 of FIG. 2 illustratively comprises a Bloom's Hierarchy or Taxonomy. The Bloom's Hierarchy/Taxonomy provides a hierarchical taxonomy in which the assumption is that one progresses thru the hierarchy by gaining proficiency/mastery at each level. In some embodiments, each level of a hierarchy of the present principles can have a set of words associated with it, and in the embodiment of FIG. 2 the words are verbs. In the embodiment of FIG. 2, each level also includes question stems or certain questions that require answers. While Bloom's Hierarchy is described with respect to FIG. 2, it should be understood that any hierarchical taxonomy can be utilized in a system, apparatus and method for data generation and training in accordance with the present principles.

In the illustrative embodiment of FIG. 2, the hierarchical taxonomy comprises six (6) layers including a remember layer 202, an understanding layer 204, an application layer 206, an analysis layer 208, an evaluation layer 210, and a create layer 212, in ascending order. In the embodiment of FIG. 2, the remember layer 202 can be used to recall facts and basic concepts and can typically be associated with stem words/verbs including, but not limited to define, duplicate, list, memorize, repeat, and state. The understanding layer 204 of FIG. 2 can be used to explain ideas or concepts and can typically be associated with words/verbs including but not limited to classify, describe, discuss, explain, identify, locate, recognize, report, select, and translate. The application layer 206 can be used to use information in new situations and can typically be associated with words/verbs including but not limited to execute, implement, solve, use, demonstrate, interpret, operate, schedule, and sketch. In the embodiment of FIG. 2, the analysis layer 208 can be used to draw connections among ideas and can typically be associated with words/verbs including but not limited to differentiate, organize, relate, compare, contrast, distinguish, examine, experiment, question, and test. The evaluation layer 210 can be used to justify a stand or decision and can typically be associated with words/verbs including but not limited to appraise, argue, defend, judge, select, support, value, critique, and weigh. As further depicted in the embodiment of FIG. 2, the create layer 212 can be used to produce new or original work and can typically be associated with words/verbs including but not limited to design, assemble, construct, conjecture, develop, formulate, author, and investigate.

Although in the embodiment of FIG. 2, the hierarchical taxonomy 200 illustratively comprises six layers in ascending order of complexity/difficulty, in alternate embodiments, a hierarchical taxonomy of the present principles can include other numbers of layers having random levels of complexity/difficulty. In accordance with the present principles, a most fundamental hierarchical taxonomy of the present principles can include at least two layers, in which the layers have different levels of complexity/difficulty. That is, as recited above each layer of a hierarchical taxonomy of the present principles have a set of words associated with the layer. The words, when applied to a respective layer, result in a level of complexity/difficulty for a respective layer resulting from what kinds of words are associated with each layer (described in greater detail below).

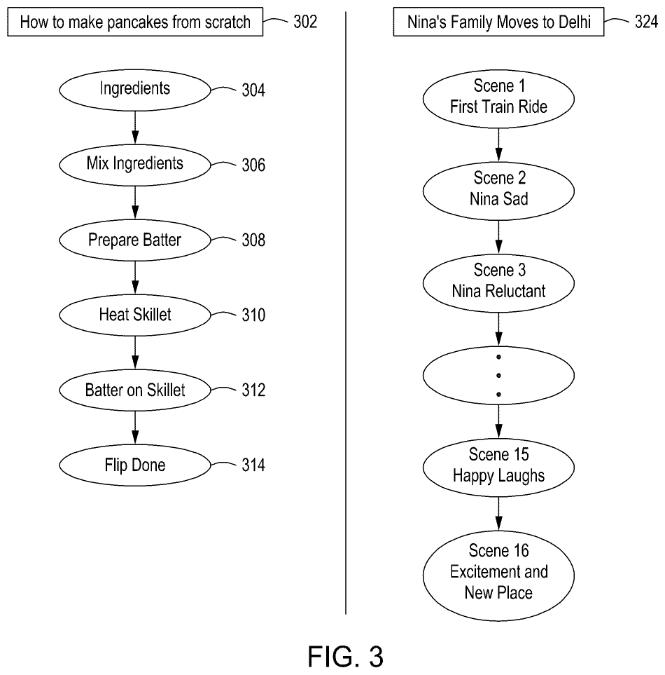

FIG. 3 depicts two examples of content that can be received and processed by a data generation and training system of the present principles, such as the data generation and training system 100 of FIG. 1. That is FIG. 3 depicts two examples of content for which question-answer pairs can be determined in accordance with the present principles. In some embodiments, the content of FIG. 3 can be received by the question-answer generation module 110 of the data generation and training system 100 of FIG. 1 and can be processed with respect to each layer of a hierarchical taxonomy of the present principles, such as the hierarchical taxonomy of FIG. 2. In some embodiments, the content data received can be known to the LLM 150, that is data previously used to train the LLM 150. Alternatively or in addition, in some embodiments, the content data received can be unknown to the LLM 150, that is data not previously used to train the LLM 150. The content data is manipulated as described below to generate question-answer pairs to ultimately be used to finetune the LLM 150 as described in further detail below.

In some embodiments, content to be used to generate question-answer pairs in accordance with the present principles can be received with content queries. That is, in some embodiments, when a data generation and training system of the present principles, such as the data generation and training system 100 of FIG. 1, receives a content query, for example intended for a language model, such as the LLM 150 of FIG. 1, the data generation and training system 100 via, for example the question-answer generation module 110, can select words in the content query received for which to generate question-answer pairs in accordance with the present principles.

In some embodiments, the content data can be received by/input to a data generation and training system of the present principles, such as the data generation and training system 100 of FIG. 1, via an input device of, for example, the computing device 1600, or can be determined by a data generation and training system of the present principles from content data received from a storage device, such as the storage device 180, which, in some embodiments, can include data from a plurality of datasets (described in further detail below).

In the embodiment of FIG. 3, the first content example 302 comprises a recipe for making pancakes from scratch. In the first example 302 of FIG. 3, such information/data for making pancakes from scratch can include, but is not limited to, information/data regarding ingredients needed for making pancakes from scratch 304, information/data regarding how to mix the ingredients 306, information/data on how to prepare the batter 308, information/data on how to heat the skillet for cooking the pancakes 310, information/data on how to put the batter on the heated skillet 312, information/data on how to flip and remove the pancake from the heated skillet 314. The question/answer generation module 110 of the data generation and training system 100 of FIG. 1 can cause the information/content data received/determined to be stored in, for example, the storage device 180 associated with the data generation and training system 100 of FIG. 1.

The second example 324 of content data depicted in FIG. 3 comprises a story entitled Nina's Family Moves to New Delhi. In accordance with the present principles, such information/content data can be communicated to a data generation and training system of the present principles via an input device of, for example, the computing device 1600 or can be determined by a data generation and training system of the present principles from content data received. As depicted in FIG. 3, information/content data associated with the story can include, but is not limited to, information/content data regarding various scenes of the story and illustratively a Scene 1 depicting a first train ride, a Scene 2 depicting a character, Nina, being sad, a Scene 3 depicting Nina's reluctance to the family's move to New Delhi, a Scene 15 depicting Nina and her family laughing, a Scene 16 depicting excitement of Nina and her family at the new home/place, and some unspecified Scenes in between Scene 3and Scene 15. The question/answer generation module 110 of the data generation and training system 100 of FIG. 1 can cause the information/data received with respect to the second example of FIG. 3 to be stored in, for example, the storage device 180 associated with the data generation and training system 100 of FIG. 1.

In the embodiment of FIG. 3, the first example, the pancake recipe, includes data structures and methods including steps and the second example, the story about Nina, includes people, scenes and events that occur in each scene of the story.

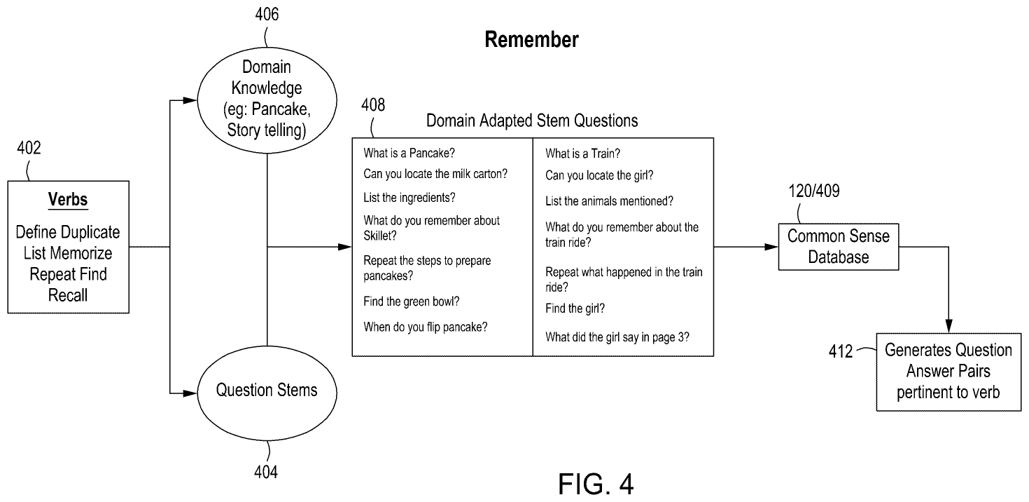

FIG. 4 depicts a functional diagram of components of the data generation and training system 100 of FIG. 1, such as the question/answer generation module 110, the optional embedding module 130, and the training module 140 as applied to the first layer (remember layer) of the hierarchical taxonomy of FIG. 2 in accordance with an embodiment of the present principles. As described with respect to FIG. 2, there are words (illustratively verbs) 402 associated with the remember layer 202 of the Bloom's taxonomy. In some embodiments, a user can generate stem questions 404 from the verbs 402 associated with the layer, for example the remember layer 202, of the Bloom's taxonomy layer. Alternatively or in addition, in some embodiments of the present principles, the stem questions can be learned and remembered from previous applications of a data generation and training system of the present principles.

In some embodiments, the question/answer generation module 110 can include a machine learning model/algorithm 112 for determining stem questions and/or question-answer pairs. The machine learning (ML) model/algorithm 112 of the question/answer generation module 110 can be trained to determine stem questions and/or question-answer pairs from words (e.g., verbs) of at least one identified layer of a hierarchical knowledge representation (e.g., Bloom's taxonomy) and received/associated content. In some embodiments of the present principles, the ML algorithm 112 can be a multi-layer neural network comprising nodes that are trained to have specific weights and biases. In some embodiments, the ML algorithm 112 employs artificial intelligence techniques or machine learning techniques to determine stem questions and/or question-answer pairs of the present principles. In some embodiments in accordance with the present principles, suitable machine learning techniques can be applied to learn commonalities in sequential application programs and for determining from the machine learning techniques at what level sequential application programs can be canonicalized. In some embodiments, machine learning techniques that can be applied to learn commonalities in sequential application programs can include, but are not limited to, regression methods, ensemble methods, or neural networks and deep learning such as ‘Se2oSeq’ Recurrent Neural Network (RNNs)/Long Short-Term Memory (LSTM) networks, Convolution Neural Networks (CNNs), graph neural networks applied to the abstract syntax trees corresponding to the sequential program application, and the like. In some embodiments a supervised ML classifier could be used such as, but not limited to, Multilayer Perceptron, Random Forest, Naive Bayes, Support Vector Machine, Logistic Regression and the like. In addition, in some embodiments, the ML algorithm of the present principles can implement at least one of a sliding window or sequence-based techniques to analyze data.

The ML algorithm 112 can be trained using a plurality (e.g., hundreds, thousands, millions) of instances of labeled content in which the training data comprises a plurality of labeled content including at least words (e.g., verbs) and associated content and resultant stem questions and/or question-answer pairs to train an ML algorithm of the present principles to determine stem questions and/or question-answer pairs from similar content data. For example, in some embodiments, training data can be constructed to include labeled content including at least one of audio data, image data, and text data associated with text (e.g., verbs) of a layer of an identified layer of a hierarchical knowledge representation (e.g., Bloom's taxonomy) along with relevant content, and the training data can be used to train the ML algorithm 112 to generate stem questions and/or question-answer pairs of the present principles.

In the embodiment of FIG. 4, the question/answer generation module 110 of the data generation and training system 100 of FIG. 1 applies the determined stem questions 404 to different instances of received/stored domain knowledge/content 406 to generate domain adapted stem questions 408. As recited above, stem questions can be determined from the verbs associated with, for example, the remember layer 202. For example, in the embodiment of FIG. 4, the remember layer 202 includes the verb “list”. In accordance with the present principles, an exemplary stem question that can be determined for the verb “list” can include “list the ingredients”. In some embodiments, the question/answer generation module 110 can apply the stem question, for example “list the ingredients” to the content data in the storage device 180 and/or to content data of the LLM 150 to determine domain adapted stem questions 408. For example, in some embodiments, the storage device 180 and/or the LLM 150 can include a plurality of recipes for making pancakes from scratch. The stem question, “list the ingredients”, can then be applied to the content domain of “making pancakes from scratch” to generate a domain adapted stem question of “list the ingredients for making pancakes from scratch”.

In some embodiments of the present principles, the question/answer generation module 110 can implement rules and/or a machine-learning process to generate the domain adapted stem questions 408 from stem questions for each layer of a hierarchical taxonomy. Alternatively or in addition, in some embodiments a human can assist in the generation of the domain adapted stem questions by applying stem questions to relevant content domains of, for example, content stored in the storage device 180 and/or the LLM 150. In yet alternate embodiments, a machine-learning process can be implemented to determine domain adapted stem questions 408 in embodiments in which a user adds to or modifies the domain knowledge applied, for example, by changing a recipe from a pancake recipe to a crepe recipe and/or by adding to or modifying the stem questions (described in greater detail below).

In the embodiment of FIG. 4, the verbs associated with the remember layer illustratively include define, duplicate, list, memorize, repeat, find and recall, and the determined, respective domain adapted stem questions for the pancake example include What is a Pancake? Can you locate the milk carton?, What do you remember about the skillet?, Repeat the steps to prepare pancakes?, Find the green bowl?, and When do you flip the pancake?.

In the embodiment of FIG. 4, the determined, respective domain adapted stem questions for the example regarding Nina's story include What is a Train?, Can you locate the girl?, List the animals mentioned?, What do you remember about the train ride?, Repeat what happened in the train ride?, Find the girl?, and What did the girl say in page 3?

In the embodiment of FIG. 4, a common sense database 409 can be used to store information/data regarding content domains used for generating respective domain adapted stem questions and differences between a specific content domain and other, different content domains (described in further detail below). In some embodiments, the common sense database 409 can comprise a reserved section(s) of the storage device 180. Alternatively or in addition, the common sense database 409 can comprise a separate storage device (not shown).

In accordance with the present principles, the process outlined in FIG. 4 can be repeated for other layers of a hierarchical taxonomy, such as the Bloom taxonomy, applied in a data generation and training system of the present principles, such as the data generation and training system 100 of FIG. 1. More specifically, in accordance with embodiments of the present principles, a layer of a hierarchical taxonomy is identified. As previously recited, each layer of the hierarchical taxonomy includes words (e.g., verbs) associated with the layer. The verbs are used to determine stem questions as described above with respect to FIG. 4. The stem questions are applied to the domain knowledge for the respective layer of the hierarchical taxonomy to determine domain adapted stem questions. As depicted in FIG. 4, question-answer pairs are determined for each of the domain adapted questions specific to each layer and in addition, at least one computational representation is determined for each layer of the hierarchical taxonomy.

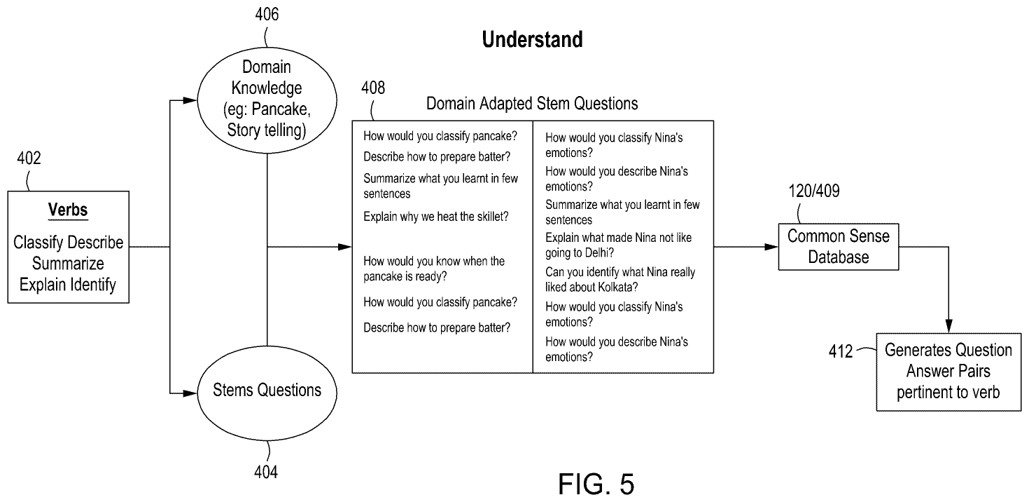

For example, FIG. 5 depicts the verbs associated with the second layer, the understand layer, which in the embodiment of FIG. 5 include classify, describe, summarize, explain and identify and the determined, respective domain adapted stem questions for the pancake example include How would you classify pancake?, Describe how to prepare the batter?, Summarize what you learned in few sentences?, Explain why we heat the skillet?, How would you know when the pancake is ready?, How would you classify pancake?, and Describe how to prepare batter?.

In the embodiment of FIG. 5, the determined, respective domain adapted stem questions for the example regarding Nina's story include How would you classify Nina's emotions?, How would you describe Nina's emotions?, Summarize what you learned in a few sentences?, Explain what made Nina not like going to Delhi?, Can you identify what Nina really liked about Kolkata?, How would you classify Nina's emotions?, and How would you describe Nina's emotions?

In the embodiment of FIG. 5, a common sense database can be used to store information/data regarding content domains used for generating respective domain adapted stem questions and differences between a specific content domain and other, different content domains. In some embodiments, the common sense database can comprise a reserved section(s) of the storage device 180. Alternatively or in addition, the common sense database can comprise a separate storage device (not shown).

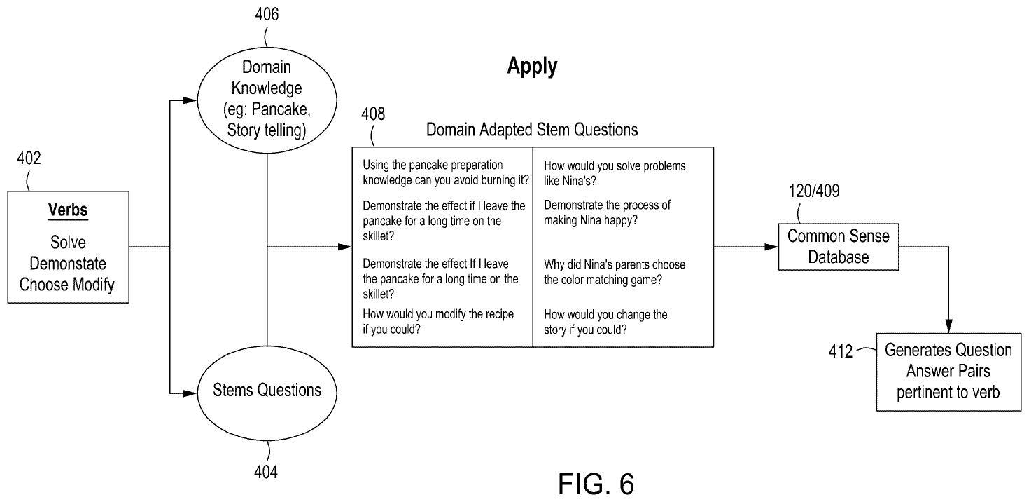

FIGS. 6, 7, 8, and 9 depict the verbs and respective domain adapted questions associated with the remaining layers of the hierarchical taxonomy of FIG. 2 and specifically, the apply layer 206, the analyze layer 208, the evaluate layer 210, and the create layer 212. For example, FIG. 6 depicts the verbs associated with the third layer of the hierarchical taxonomy of FIG. 2, the apply layer, which in the embodiment of FIG. 6 include solve, demonstrate, choose, modify and the determined, respective domain adapted stem questions for the pancake example include Using the pancake preparation knowledge, can you avoid burning it?, Demonstrate the effect if I leave the pancake for a long time on the skillet?, Why did we choose sugar for Pancake and not salt?, and How would you modify the recipe if you could?.

In the embodiment of FIG. 6, the determined, respective domain adapted stem questions for the example regarding Nina's story include How would you solve problems like Nina's?, Demonstrate the process of making Nina happy?, Why did Nina's parents choose the color matching game?, and How would you change the story if you could?

As further depicted in FIG. 6, the computational module 120 of the data generation and training system 100 of FIG. 1 uses the determined domain adapted questions to generate a computational representation as described above. That is, in the embodiment of FIG. 6, a common sense database can be used to store information/data regarding content domains used for generating respective domain adapted stem questions and differences between a specific content domain and other, different content domains. In some embodiments, the common sense database can comprise a reserved section(s) of the storage device 180. Alternatively or in addition, the common sense database can comprise a separate storage device (not shown).

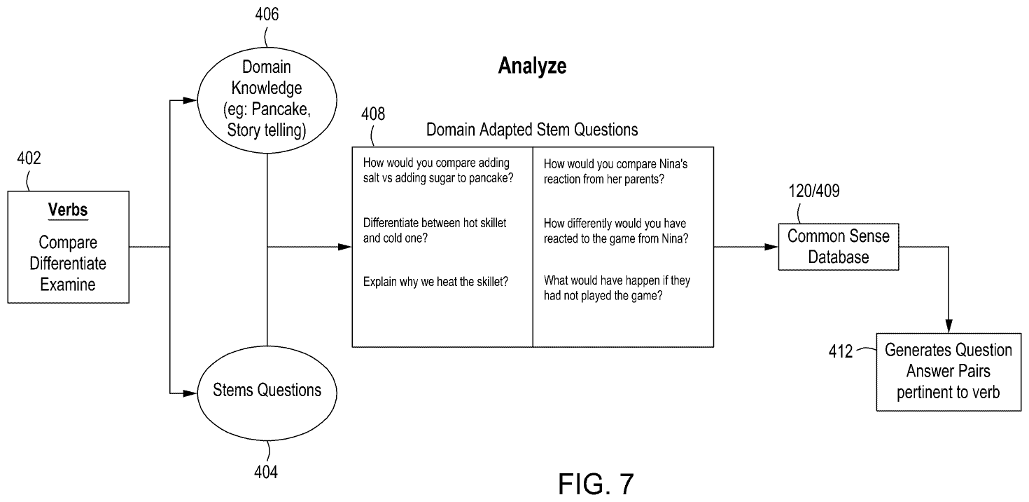

FIG. 7 illustratively depicts the verbs associated with the fourth layer of the hierarchical taxonomy of FIG. 2, the analyze layer, which in the embodiment of FIG. 7 include compare, differentiate, and examine and the determined, respective domain adapted stem questions for the pancake example include How would you compare adding salt vs adding sugar to pancake?, Differentiate between hot skillet and cold one?, and Explain why we heat the skillet?.

In the embodiment of FIG. 7, the determined, respective domain adapted stem questions for the example regarding Nina's story include How would you compare Nina's reaction from her parents?, How differently would you have reacted to the game from Nina?, and What would have happened if they had not played the game?

In the embodiment of FIG. 7, a common sense database can be used to store information/data regarding content domains used for generating respective domain adapted stem questions and differences between a specific content domain and other, different content domains. In some embodiments, the common sense database can comprise a reserved section(s) of the storage device 180. Alternatively or in addition, the common sense database can comprise a separate storage device (not shown).

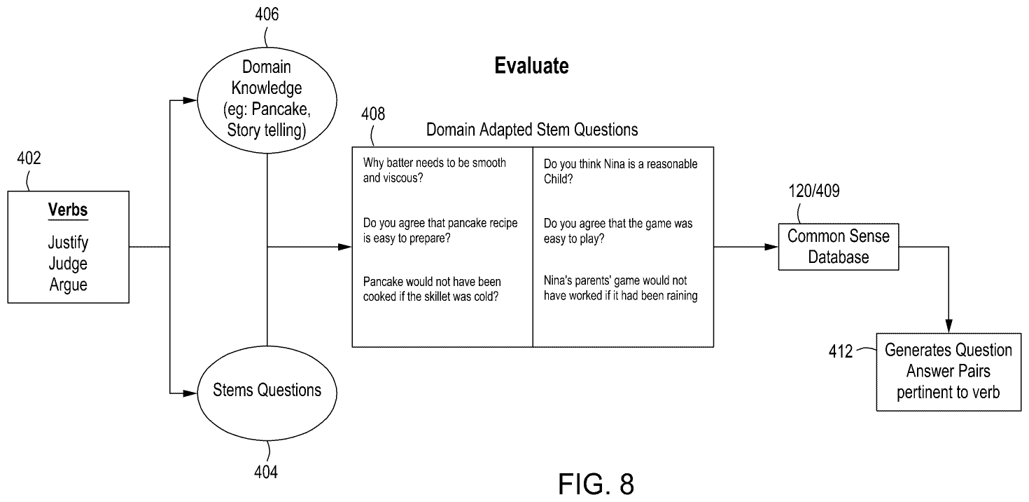

FIG. 8 illustratively depicts the verbs associated with the fifth layer of the hierarchical taxonomy of FIG. 2, the evaluate layer, which in the embodiment of FIG. 8 include justify, judge and argue and the determined, respective domain adapted stem questions for the pancake example include Why does the batter need to be smooth and viscous?, Do you agree that the pancake recipe is easy to prepare?, and The pancake would not have been cooked if the skillet was cold?.

In the embodiment of FIG. 8, the determined, respective domain adapted stem questions for the example regarding Nina's story include Do you think Nina is a reasonable child?, Do you agree that the game was easy to play?, and Nina's parents' game would not have worked if it had been raining.

In the embodiment of FIG. 8, a common sense database can be used to store information/data regarding content domains used for generating respective domain adapted stem questions and differences between a specific content domain and other, different content domains. In some embodiments, the common sense database can comprise a reserved section(s) of the storage device 180. Alternatively or in addition, the common sense database can comprise a separate storage device (not shown).

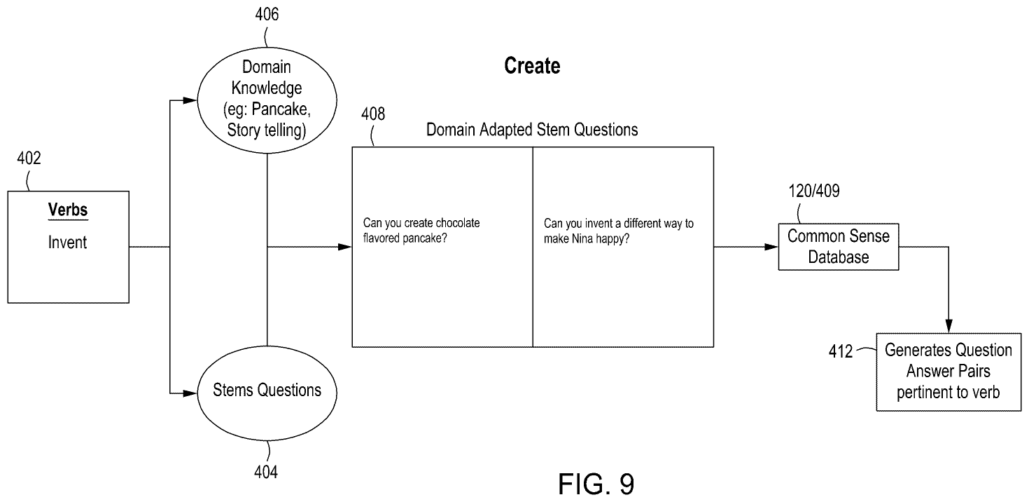

FIG. 9 illustratively depicts the verbs associated with the sixth layer of the hierarchical taxonomy of FIG. 2, the create layer, which in the embodiment of FIG. 9 include invent and the determined, respective domain adapted stem questions for the pancake example include Can you create chocolate flavored pancake?

In the embodiment of FIG. 9, the determined, respective domain adapted stem questions for the example regarding Nina's story include Can you invent a different way to make Nina happy?.

In the embodiment of FIG. 9, a common sense database can be used to store information/data regarding content domains used for generating respective domain adapted stem questions and differences between a specific content domain and other, different content domains. In some embodiments, the common sense database can comprise a reserved section(s) of the storage device 180. Alternatively or in addition, the common sense database can comprise a separate storage device (not shown).

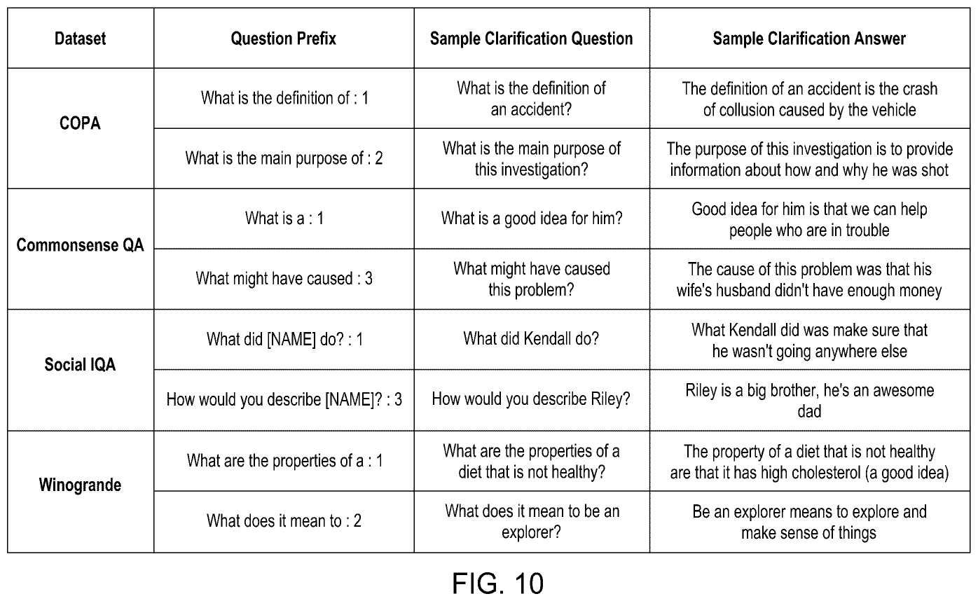

FIG. 10 depicts a Table of example question-answer pairs determined by a data generation and training system of the present principles, such as the data generation and training system 100 of FIG. 1, from content associated with various datasets in accordance with at least one embodiment of the present principles, as described herein. In the Table of FIG. 10, a first column lists datasets of content illustratively including a Choice of Plausible Alternatives (COPA) dataset, a Commonsense QA dataset, a Social IQA dataset, and a Winogrande dataset. A second column of the Table of FIG. 10 illustratively depicts two respective domain adapted prefixes for stem questions for each dataset. Illustratively, the second column of FIG. 10 includes the respective prefixes of “what is the definition of” and what is the main purpose of” for the COPA dataset, “what is” and “what might have caused” for the Commonsense QA dataset”, “what did [NAME] do” and “how would you describe [NAME]” for the Social IQA dataset, and “what are the properties of a” and “what does it mean to” for the Winogrande dataset. In the Table of FIG. 10, the second column further includes a number associated with each prefix, which reflects a level in a taxonomy, such as Bloom's Taxonomy, with which each prefix is associated in accordance with the present principles. The third column of the Table of FIG. 10 includes question-answer pairs, illustratively one question-answer pair for each of the stem prefixes. As described above, in some embodiments, the question-answer pairs of the present principles and as depicted in FIG. 10, can be determined by a ML algorithm/model of the present principles, such as the ML algorithm 112 of the question/answer generation module 110 of the present principles.

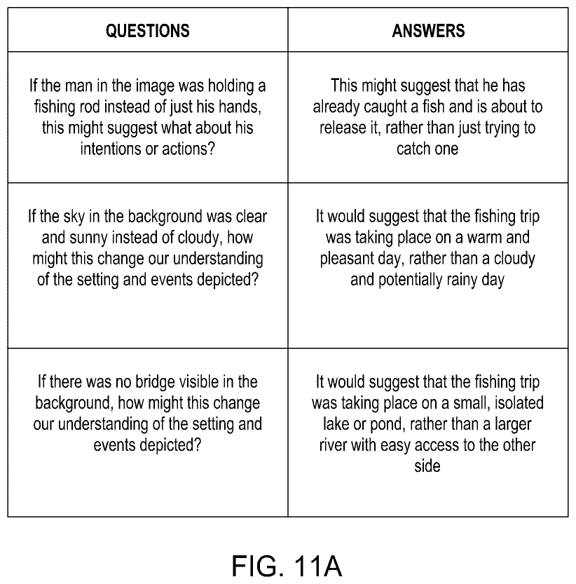

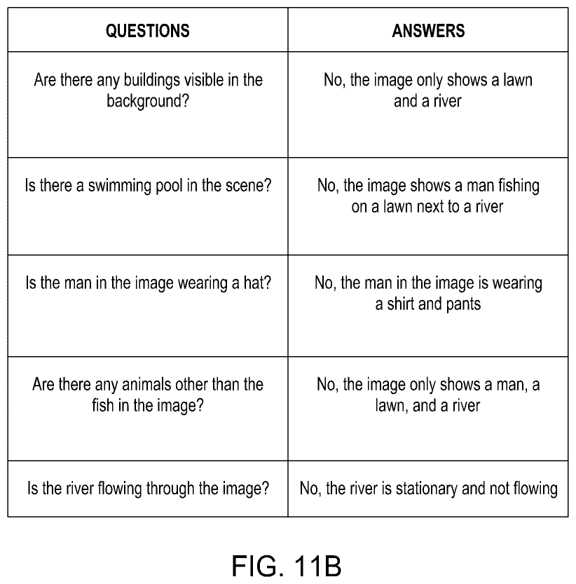

As previously recited above, embodiments of the present principles include the generation of question-answer pairs intended to increase a semantic understanding of associated content when used to finetune a language model, such as the LLM 150 of FIG. 1. For example, FIG. 11A depicts a Table including question-answer pairs intended to increase the semantic understanding of content of an image of a fishing trip when the determined question-answer pairs are implemented to finetune a language model. In the Table of FIG. 11A, the first column, first row includes the determined question “If the man in the image was holding a fishing rod instead of just a fish in his hands, this might suggest what about his intentions or actions?”. In the Table of FIG. 11A, the second column, first row includes a relatively determined answer “This might suggest that he has already caught a fish and is about to release it, rather than just trying to catch one.”. The question-answer pair of the present principles depicted in the first row of the Table of FIG. 11A teaches a semantic relationship between at least the man, the man's hands, the fish, and the fishing rod. That is, the determined question-answer pair, when implemented to finetune a language model, can increase the language model's understanding of the image, and specifically can increase the language model's semantic understanding that the man in the image has caught a fish and is about to release the fish.

Furthermore, in the Table of FIG. 11A, a second row includes the question “If the sky in the background was clear and sunny instead of cloudy, how might this change our understanding of the setting and events depicted?” and the corresponding answer “It would suggest that the fishing trip was taking place on a warm and pleasant day, rather than a cloudy and potentially rainy day.”. The question-answer pair of the present principles depicted in the second row of the Table of FIG. 11A teaches a semantic relationship between at least the sky, the sun, rain, clouds and the fishing trip. That is, the determined question-answer pair, when implemented to finetune a language model, can increase the language model's understanding of the image, and specifically can increase the language model's semantic understanding that the fishing trip was taking place on a warm and pleasant day.

Even further, in the Table of FIG. 11A, a third row includes the question “If there was no bridge visible in the background, how might this change our understanding of the setting and events depicted?” and the corresponding answer “It would suggest that the fishing trip was taking place on a small, isolated lake or pond, rather than a larger river with easy access to the other side.”

As depicted in the Table of FIG. 11A, the question-answer pairs determined in accordance with the present principles identify semantic information determined from interrelationships of objects present in an image and even information that can be determined from an interrelationship of objects that can be included in or removed from the image. Although in the embodiment of FIG. 11A, the question-answer pairs are directed to increasing a semantic understanding of interrelationships of objects in an image, embodiments of the present principles can include the generation of question-answer pairs intended to increase a semantic understanding of words in text (e.g., sentences, paragraphs stories, etc.) and/or to increasing the semantic understanding of words and objects in multimodal content by at least defining/identifying relationships between the components of the content.

For example, in one embodiment of a story in which Nina is taking a train trip, a question determined in accordance with the present principles can recite “If Nina's home was in Miami and the train's last stop was Miami, how might this characterize the train's last stop?” and the corresponding answer “It would suggest that the train's last stop was Nina's final destination.” In the example described, the determined question-answer pair, when implemented to finetune a language model, can increase the language model's understanding of the story, and specifically can increase the language model's semantic understanding that the train's last stop is Nina's final destination.

As previously recited above, embodiments of the present principles include the generation of question-answer pairs intended to increase a semantic understanding of associated content when used to finetune a language model, such as the LLM 150 of FIG. 1. In some embodiments, question-answer pairs of the present principles can provide counter-factual/negative examples of relationships between components in content to be used to increase a semantic understanding of the content when implemented, for example, to finetune a language model. For example, FIG. 11B depicts a Table including counter-factual/negative question-answer pairs intended to increase the semantic understanding of content of the image of the fishing trip associated with FIG. 11A when the determined question-answer pairs are implemented to finetune a language model.

In the Table of FIG. 11B, the first column, first row includes the determined question “Are there any buildings visible in the background?”. In the Table of FIG. 11B, the first column, first row includes a relatively determined answer “No, the image only shows a lawn and a river.”. The question-answer pair of the present principles depicted in the first row of the Table of FIG. 11B teaches a semantic relationship between at least the man, the lawn, the river, and that there are no buildings in the image. That is, the determined question-answer pair, when implemented to finetune a language model, can increase the language model's understanding of the image, and specifically can increase the language model's semantic understanding that there are no buildings in the area of the fishing area, which includes a lawn and a river.

Furthermore, in the Table of FIG. 11B, a second row includes the question “Is there a swimming pool in the scene?” and the corresponding answer “No, the image shows a man fishing on a lawn next to a river.”. The question-answer pair of the present principles depicted in the second row of the Table of FIG. 11B teaches a semantic relationship between at least the man, the lawn, and the river and makes clear that there is no swimming pool in the scene.

Even further, in the Table of FIG. 11B, a third row includes the question “Is the man in the image wearing a hat?” and the corresponding answer “No, the man in the image is wearing a shirt and pants.”. The question-answer pair of the present principles depicted in the third row of the Table of FIG. 11B teaches a semantic relationship between at least the man, the pants, and the shirt and makes clear that the man is not wearing a hat.

Furthermore, in the Table of FIG. 11B, a fourth row includes the question “Are there any animals other than the fish in the image?” and the corresponding answer “No, the image only shows a man, a lawn, and a river.”. The question-answer pair of the present principles depicted in the fourth row of the Table of FIG. 11B teaches a semantic relationship between at least the man, the lawn, and the river and makes clear that, other than a fish, there are no animals in the scene.

Lastly, in the Table of FIG. 11B, a fifth row includes the question “Is the river flowing through the image?” and the corresponding answer “No, the river is stationary and not flowing.”. The question-answer pair of the present principles depicted in the fifth row of the Table of FIG. 11B teaches a semantic relationship between at least the river and the remaining objects in the scene by identifying that the river is stationary in the scene.

As depicted in the Table of FIG. 11B, the counter-factual/negative question-answer pairs determined in accordance with the present principles determine/identify semantic information determined from interrelationships of objects present and not present in an image Although in the embodiment of FIG. 11B, the question-answer pairs are directed to increasing a semantic understanding of interrelationships of objects in an image, embodiments of the present principles can include the generation of question-answer pairs intended to increase a semantic understanding of words in text (e.g., sentences, paragraphs stories, etc.) and/or to increasing the semantic understanding of words and objects in multimodal content by at least defining/identifying relationships between the components of the content.

In accordance with the present principles, question-answer pairs intended to increase a semantic understanding of content, as depicted in at least FIG. 11A and FIG. 11B, can be created in accordance with the present principles for any and all layers of a hierarchical taxonomy of the present principles.

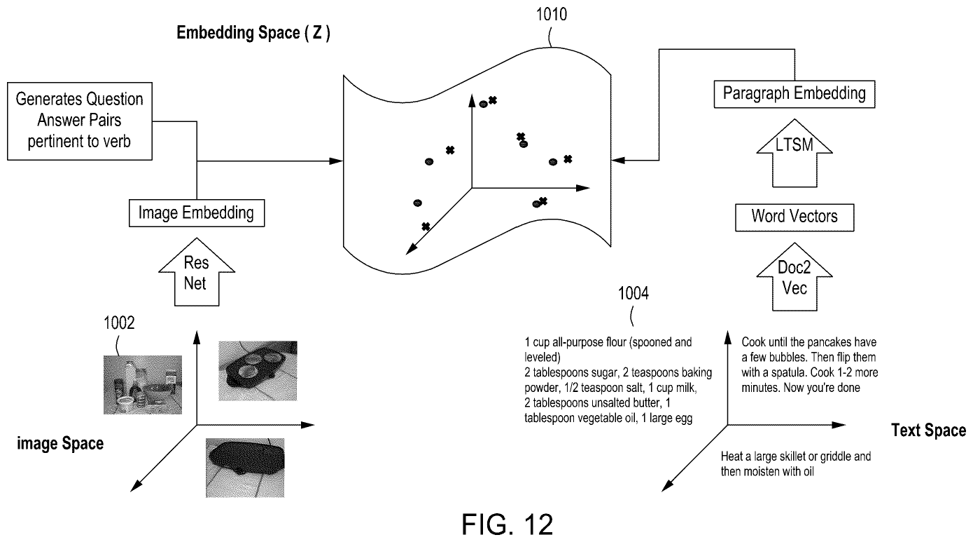

FIG. 12 depicts a graphical representation of an embedding/training process in accordance with an embodiment of the present principles. The embodiment of FIG. 12 includes a machine learning process of the present principles as described with respect to the first layer (remember layer) 202 of the hierarchical taxonomy 200 of the embodiment of FIG. 2. In accordance with the present principles, generated question-answer pairs are embedded in a common/joint embedding space 1010. That is, as depicted in FIG. 12, in accordance with the present principles, image content 1002, text content 1004 and audio content (not shown) of a content domain for which a respective domain adapted stem question was generated can be embedded in a common embedding space 1010 during training. The content to be embedded can include recipes for making pancakes from scratch, stories about Nina traveling on a train, recipes for making crepes, stories about Nina traveling in a car, and any other content a user may think is relevant to include in the embedding space. Illustratively in the embodiment of FIG. 12, images and text regarding how to make pancakes from scratch are being embedded into the common embedding space. In the embodiment of the data generation and training system 100 of FIG. 1, such embedding can be performed by the optional embedding module 130. As depicted in FIG. 12, the embedding module embeds information/data related to the generated question-answer pairs 1008 determined from each of the domain adapted stem questions and the related content in the content domain, from which the domain related stem questions were generated in each layer of the hierarchical taxonomy, and illustratively in FIG. 12, for the remember layer 202 of the hierarchical taxonomy depicted in FIG. 2. In some embodiments, image content is embedded into a joint/common embedding space 1010 by the optional embedding module 130 by, illustratively in FIG. 12, applying ResNet techniques, which include a pretrained Deep Learning model for image classification of the Convolutional Neural Network (CNN, or ConvNet), which includes a class of deep neural networks applied to analyzing visual imagery. That is, in some embodiments of the present principles the optional embedding module 130 determines a vector representation of the image content to embed the image content into the joint/common embedding space 1010. Although in the embodiment of FIG. 12 ResNet techniques are implemented to embed visual content, alternatively or in addition, other known visual content embedding techniques can be implemented in accordance with the present principles.

Illustratively, in the embodiment of FIG. 12, text/document content can be embedded in the common embedding space 1010 by applying Doc2Vec/Word2Vec techniques, which include algorithms which use a neural network model to learn word associations from a large corpus of text/documents. As the name implies, Doc2Vec/Word2Vec represents each distinct word/group of words with a particular list of numbers called a vector. That is, in some embodiments of the present principles the optional embedding module 130 determines a vector representation of the text/document content to embed the content into the joint/common embedding space 1010. Although in the embodiment of FIG. 12 Doc2Vec/Word2Vec techniques are implemented to embed text/documents, alternatively or in addition, other known text content embedding techniques can be implemented in accordance with the present principles. As further depicted in FIG. 12, in some embodiments, Long Short-Term Memory (LSTM) techniques can be applied to, for example, the text/phrase embedding. LSTM techniques include a type of recurrent neural network capable of learning order dependence.

In accordance with the present principles, the determined vector representations for the content are embedded in the common/joint embedding space along with a respective domain adapted stem question such that embedded vector representations for the domain adapted questions and embedded content vector representations that are related, are closer together in the common embedding space than unrelated vector representations embedded for the domain adapted questions and embedded content vector representations.

The common/joint embedding space 1010 is trained as described above for each respective question-answer pair of each layer of the hierarchical taxonomy of the present principles. More specifically, the training of the common/joint embedding space 1010 of FIG. 12 with respect to the training of question-answer pairs for the remember layer 202 of the hierarchical taxonomy of FIG. 2 is applied to each of the other layers of the hierarchical taxonomy 200 of the present principles. Because the common embedding space 1010 of the present principles comprises embedded question-answer pairs for each of the layers of a hierarchical taxonomy of the present principles, a relationship between embedded question-answer pairs of varying complexity can be determined.

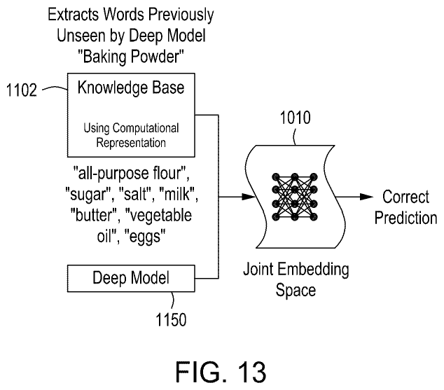

In accordance with the present principles, the training and embedding of the present principles, for example as described with respect to FIG. 12, can generate a model (depicted in FIG. 13) for each of the domain adapted questions in each layer of the hierarchical taxonomy. For example and with respect to the embodiment of FIG. 12, a data generation and training system of the present principles, such as the data generation and training system 100 of FIG. 1, can create a model (depicted in FIG. 13) associated with a domain adapted question, which requests a list of ingredients for making a pancake (e.g., what is a list of ingredients for making a pancake?) in a remember layer 202 of a hierarchical taxonomy of the present principles. In accordance with the present principles, a model can be determined for each domain adapted question for each of the layers of a hierarchical taxonomy.

At a higher level, the training and embedding of the present principles, for example as described with respect to FIG. 12, can generate a model for each domain of content in each layer of the hierarchical taxonomy. For example and with respect to the embodiment of FIG. 12, a data generation and training system of the present principles, such as the data generation and training system 100 of FIG. 1, can create a higher-level model for how to make a pancake from scratch for each layer of the hierarchical taxonomy (illustratively in FIG. 12 the remember layer 202), which in some embodiments would include embeddings associated with all respective domain adapted stem questions for each layer (e.g., the remember layer) of the hierarchical taxonomy.

In accordance with the present principles, the determined models can be implemented by a data generation and training system of the present principles, such as the data generation and training system 100 of FIG. 1, to more thoroughly comprehend content processed as described above and to more accurately retrieve stored, processed content for example from a storage device, such as the storage device 180 of the data generation and training system 100 of FIG. 1.

In accordance with the present principles, the models determined by a data generation and training system of the present principles, such as the data generation and training system 100 of FIG. 1, can be implemented to train the LLM 150 of the data generation and training system 100 of FIG. 1, for content directly related to a model and also for content not directly related to a determined model. For example, FIG. 13 depicts a graphical representation of the adaptation of a model 1150 determined for a list of ingredients for making pancakes, as described above, to a list of ingredients for making crepes.

In the embodiment of FIG. 13, the embedding module 130 of the data generation and training system 100 of FIG. 1 can be further configured to compare content information 1102 of ingredients for making crepes previously determined by the data generation and training system 100 of FIG. 1 and stored, for example, in the storage device/knowledge base as described above, to information in the previously determined model 1150 for ingredients for making pancakes to determine a content difference between ingredients needed for making pancakes and ingredients needed for making crepes. A resultant vector representation of the content differences between ingredients needed for making pancakes and ingredients needed for making crepes and the previously determined model 1150 for ingredients for making pancakes is determined and can be projected into a joint embedding space of the present principles, such as the joint embedding space 1010 of FIG. 12, by, for example the embedding module 130. The result of the projected resultant vector of the content differences between ingredients needed for making pancakes and ingredients needed for making crepes and the previously determined model 1150 for ingredients for making pancakes represents a vector location in the joint embedding space 1010 that includes content that represents ingredients for making crepes.

The above described procedure of FIG. 13 for the adaptation of a model determined by the data generation and training system 100 of FIG. 1 to content not directly related to the determined model can be implemented with any model determined by a data generation and training system of the present principles, such as the data generation and training system 100 of FIG. 1 and for any layer of a hierarchical taxonomy of the present principles.

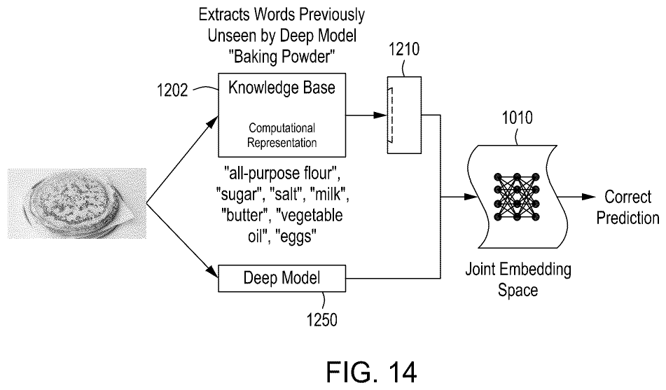

In an alternate embodiment of the present principles, the procedure described in FIG. 13 can be adapted to further include the application of logical rules for the adaptation of a content model determined by a data generation and training system of the present principles to content not directly related to the content model. For example, FIG. 14 depicts a graphical representation of an adaptation of a model determined for a list of ingredients for making pancakes to a list of ingredients for making crepes including logical rules in accordance with an embodiment of the present principles. In the embodiment of FIG. 14, the embedding module 130 of the data generation and training system 100 of FIG. 1 compares content information 1202 of ingredients for making crepes previously determined by the data generation and training system 100 of FIG. 1 and stored, for example, in the storage device 180 to information in the previously determined model 1250 for ingredients for making pancakes to determine a content difference between ingredients needed for making pancakes and ingredients needed for making crepes. In the embodiment of FIG. 14, the embedding module 130 of the data generation and training system 100 of FIG. 1 can apply rules 1210 to previously received content regarding ingredients for making crepes to limit the content that is compared to the previously determined model 1250 for ingredients for making pancakes for determining differences, which ultimately limits and more narrowly defines a determined vector that is determined for the content differences between ingredients needed for making pancakes and ingredients needed for making crepes and the previously determined model 1250 for ingredients for making pancakes, which vector is projected into the joint embedding space of the present principles, such as the joint embedding space 1010 of FIG. 12.

More specifically, in the embodiment of FIG. 14, a rule 1210 can be applied by the embedding module 130 to the previously received content defining ingredients for making crepes that indicates that ingredients for making crepes must include salt. As such, only previously received content for ingredients for making crepes that include salt will be considered when determining differences between ingredients needed for making pancakes and ingredients needed for making crepes and the previously determined model 1260 for ingredients for making pancakes. A resultant vector for a combination of the determined differences and the previously determined model 1250 for ingredients for making pancakes is determined and can be projected into a joint embedding space, such as the joint embedding space 1010 depicted in the embodiment of FIG. 12, by, for example, the optional embedding module 130. The result of the projected resultant vector of the content differences between ingredients needed for making pancakes and ingredients needed for making crepes which include salt and the previously determined model 1250 for ingredients for making pancakes is a vector in the joint embedding space 1010 that represents content related to ingredients for making crepes, which is limited and constrained by the applied rules, which results in a more accurate determination of the resultant vector and subsequently determined ingredients for making crepes.

The information determined by a data generation and training system of the present principles, such as the data generation and training system 100 of FIG. 1, as described above, can be used by, for example the training module 140 of FIG. 1, to finetune the LLM 150 of FIG. 1. For example, the question/answer pairs determined by the data generation and training system 100 of FIG. 1 and, in some embodiments, stored in the storage device 180, can be used to finetune the LLM 150 to improve the higher-level reasoning performance of the LLM 150. That is, in some embodiments, the determined question/answer pairs determined in accordance with the present principles and as described above, can be used to train a pre-existing model of the LLM 150 by adjusting the weights through supervised learning.

In some embodiments, a data generation and training system of the present principles, such as the data generation and training system 100 of FIG. 1, can comprise and/or include an adaptor. In such embodiments, the adaptor weights can be learned on question-answer pairs (i.e., the dataset) determined in accordance with the present principles, while a backbone of a subject language model, such as the LLM 150 of FIG. 1, are kept frozen. Embodiments of the present principles eliminate the sizable computational effort of retraining the LLM 150 anew.

In embodiments of the present principles, new data is created through a process known as query expansion. That is, in some embodiments, a query for each level of a subject taxonomy (e.g., Bloom's taxonomy) is generated from an original query. As such, each new query is now associated with additional question-answer pairs. As such, embodiments of the present principles generate an augmented dataset. When a language model, such as the LLM 150 of FIG. 1, is trained using the augmented dataset, in accordance with the present principles, a higher-level reasoning performance of language model-based systems, such as Large Language Model-based systems, are improved because of the finetuning of the language model via the augmented dataset having the semantic expansion of context developed using a hierarchical guidance of the present principles. In accordance with some embodiments of the present principles, a data generation and training system of the present principles, such as the data generation and training system 100 of FIG. 1, which can be implemented as an adaptor, learns a context (i.e., semantic understanding) around received content (e.g., in addition each query) and applies such context to answering the query.

In addition, in some embodiments, other information determined by a data generation and training system of the present principles, such as the models and data/information determined with respect to an embedding space of the present principles as described in FIGS. 12-14 can be used to finetune the LLM 150 to improve the higher-level reasoning performance of the LLM 150 at least with respect to the data associated with the determined models in accordance with the present principles.

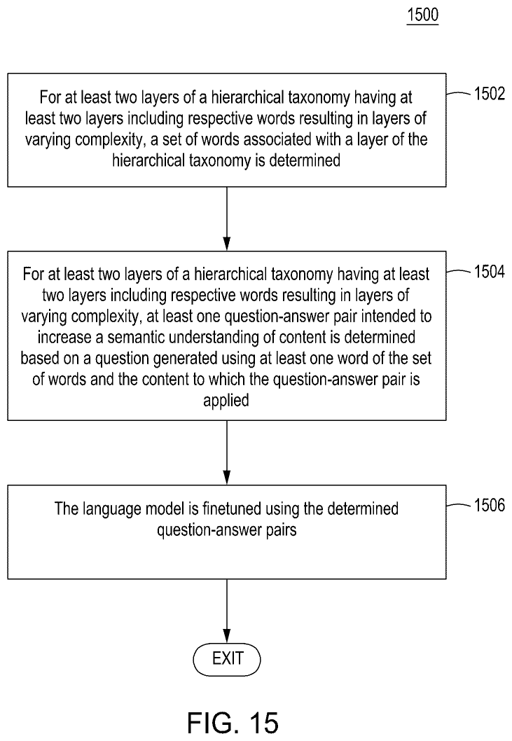

FIG. 15 depicts a flow diagram of a method 1500 for determining question-answer pairs and finetuning a language model. The method 1500 of FIG. 15 can begin at 1502 during which for at least two layers of a hierarchical taxonomy having at least two layers including respective words resulting in layers of varying complexity, a set of words associated with a layer of the hierarchical taxonomy is determined. The method 1500 can proceed to 1504.

At 1504, for at least two layers of a hierarchical taxonomy having at least two layers including respective words resulting in layers of varying complexity, at least one question-answer pair intended to increase a semantic understanding of content is determined based on a question generated using at least one word of the set of words and the content to which the question-answer pair is applied. The method 1500 can proceed to 1506.

At 1506, the language model is finetuned using the determined question-answer pairs. The method 1500 can then be exited.

In some embodiments, the content of the at least one content domain includes content known to the language model. In some embodiments, the content of the at least one content domain comprises content not known to the language model.

In some embodiments, the at least one question-answer pair intended to increase the semantic understanding of the content identifies a relationship among the components of the content.

In some embodiments, the components of the content include at least one of text content, image content, or a combination of text and image content.

In some embodiments, the finetuning of the language model increases the language model's semantic understanding of the content.

In some embodiments, generating the at least one question answer pair further includes determining at least one stem question for a word of the set of words, and determining at least one respective domain adapted question for at least one stem question based on at least one content domain, where the at least one respective domain adapted question is used to generate the at least one question-answer pair.

In some embodiments, the method further includes for each determined question-answer pair, determining a vector representation for the at least one question-answer pair and for content related to the at least one content domain of the at least one question-answer pair, and embedding the vector representation determined for the at least one question-answer pair and the vector representation determined for the content related to the content domain into a common embedding space such that embedded vector representations for question-answer pairs and embedded vector representations for content related to the content domain that are related, are closer together in the common embedding space than unrelated embedded vector representations, where the common embedding space comprises embedded question-answer pairs for each of the at least two layers of the hierarchical taxonomy, such that a relationship between embedded-question-answer pairs of varying complexity can be determined.

In some embodiments, the method further includes determining a content model for at least one of, each of the determined questions answer pairs in each of the at least two layers of the hierarchical taxonomy or for all of the question-answer pairs determined for the hierarchical taxonomy, collectively.

In some embodiments, the method further includes adapting a determined content model to apply to content not directly represented by the content model.

In some embodiments, the method further includes finetuning the language model using at least one of the content model or the adapted content model.

In some embodiments an apparatus includes a processor and a memory coupled to the processor, the memory having stored therein at least one of programs or instructions. In some embodiments, when the processor executes the programs or instructions, the apparatus is configured to, for at least two layers of a hierarchical taxonomy having at least two layers including respective words resulting in layers of varying complexity, determine a set of words associated with a layer of the hierarchical taxonomy, determine at least one question-answer pair intended to increase a semantic understanding of content based on a question generated using at least one word of the set of words and the content to which the question-answer pair is applied, and finetune the language model using the determined question-answer pairs.

In some embodiments a system includes a language model and an apparatus including a processor and a memory coupled to the processor, the memory having stored therein at least one of programs or instructions. In some embodiments, when the processor executes the programs or instructions, the apparatus is configured to, for at least two layers of a hierarchical taxonomy having at least two layers including respective words resulting in layers of varying complexity, determine a set of words associated with a layer of the hierarchical taxonomy, determine at least one question-answer pair intended to increase a semantic understanding of content based on a question generated using at least one word of the set of words and the content to which the question-answer pair is applied, and finetune the language model using the determined question-answer pairs.

As depicted in FIG. 1, embodiments of a data generation and training system of the present principles, such as the data generation and training system 100 of FIG. 1, can be implemented in a computing device 1600 in accordance with the present principles. That is, in some embodiments, multimodal content, questions regarding the multimodal content, data and the like can be communicated to components of the data generation and training system 100 of FIG. 1 using the computing device 1600 via, for example, any input/output means associated with the computing device 1600. Data associated with a data generation and training system in accordance with the present principles can be presented to a user using an output device of the computing device 1600, such as a display, a printer or any other form of output device.

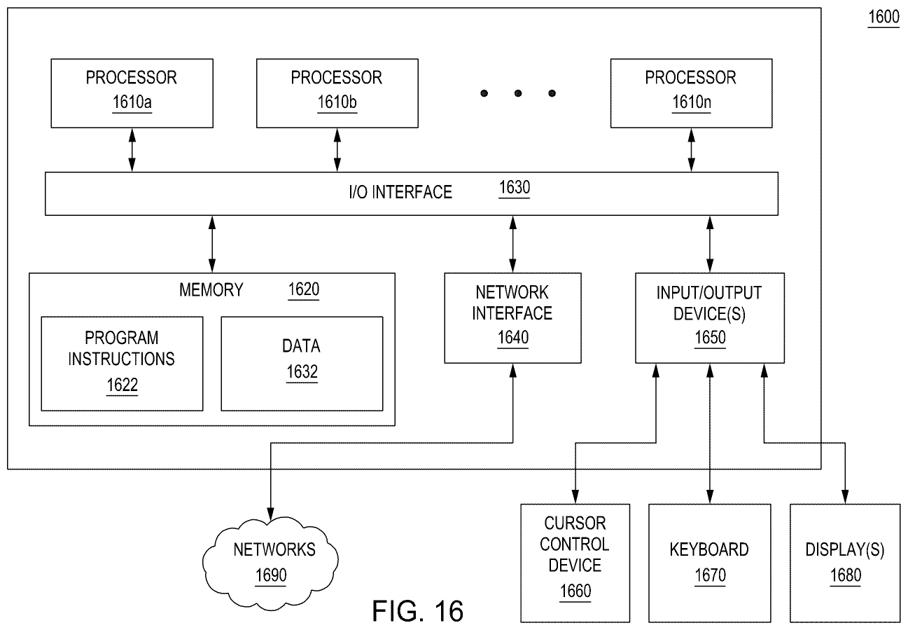

For example, FIG. 16 depicts a high-level block diagram of a computing device 1600 suitable for use with embodiments of a data generation and training system in accordance with the present principles such as the data generation and training system 100 of FIG. 1. In some embodiments, the computing device 1600 can be configured to implement methods of the present principles as processor-executable executable program instructions 1622 (e.g., program instructions executable by processor(s) 1610) in various embodiments.

In the embodiment of FIG. 16, the computing device 1600 includes one or more processors 1610a-1610n coupled to a system memory 1620 via an input/output (I/O) interface 1630. The computing device 1600 further includes a network interface 1640 coupled to I/O interface 1630, and one or more input/output devices 1650, such as cursor control device 1660, keyboard 1670, and display(s) 1680. In various embodiments, a user interface can be generated and displayed on display 1680. In some cases, it is contemplated that embodiments can be implemented using a single instance of computing device 1600, while in other embodiments multiple such systems, or multiple nodes making up the computing device 1600, can be configured to host different portions or instances of various embodiments. For example, in one embodiment some elements can be implemented via one or more nodes of the computing device 1600 that are distinct from those nodes implementing other elements. In another example, multiple nodes may implement the computing device 1600 in a distributed manner.

In different embodiments, the computing device 1600 can be any of various types of devices, including, but not limited to, a personal computer system, desktop computer, laptop, notebook, tablet or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, the computing device 1600 can be a uniprocessor system including one processor 1610, or a multiprocessor system including several processors 1610 (e.g., two, four, eight, or another suitable number). Processors 1610 can be any suitable processor capable of executing instructions. For example, in various embodiments processors 1610 may be general-purpose or embedded processors implementing any of a variety of instruction set architectures (ISAs). In multiprocessor systems, each of processors 1610 may commonly, but not necessarily, implement the same ISA.

System memory 1620 can be configured to store program instructions 1622 and/or data 1632 accessible by processor 1610. In various embodiments, system memory 1620 can be implemented using any suitable memory technology, such as static random-access memory (SRAM), synchronous dynamic RAM (SDRAM), nonvolatile/Flash-type memory, or any other type of memory. In the illustrated embodiment, program instructions and data implementing any of the elements of the embodiments described above can be stored within system memory 1620. In other embodiments, program instructions and/or data can be received, sent or stored upon different types of computer-accessible media or on similar media separate from system memory 620 or computing device 1600.

In one embodiment, I/O interface 1630 can be configured to coordinate I/O traffic between processor 1610, system memory 1620, and any peripheral devices in the device, including network interface 1640 or other peripheral interfaces, such as input/output devices 1650. In some embodiments, I/O interface 1630 can perform any necessary protocol, timing or other data transformations to convert data signals from one component (e.g., system memory 1620) into a format suitable for use by another component (e.g., processor 1610). In some embodiments, I/O interface 1630 can include support for devices attached through various types of peripheral buses, such as a variant of the Peripheral Component Interconnect (PCI) bus standard or the Universal Serial Bus (USB) standard, for example. In some embodiments, the function of I/O interface 1630 can be split into two or more separate components, such as a north bridge and a south bridge, for example. Also, in some embodiments some or all of the functionality of I/O interface 1630, such as an interface to system memory 1620, can be incorporated directly into processor 1610.

Network interface 1640 can be configured to allow data to be exchanged between the computing device 1600 and other devices attached to a network (e.g., network 1690), such as one or more external systems or between nodes of the computing device 1600. In various embodiments, network 1690 can include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 1640 can support communication via wired or wireless general data networks, such as any suitable type of Ethernet network, for example; via digital fiber communications networks; via storage area networks such as Fiber Channel SANs, or via any other suitable type of network and/or protocol.

Input/output devices 1650 can, in some embodiments, include one or more display terminals, keyboards, keypads, touchpads, scanning devices, voice or optical recognition devices, or any other devices suitable for entering or accessing data by one or more computer systems. Multiple input/output devices 1650 can be present in computer system or can be distributed on various nodes of the computing device 1600. In some embodiments, similar input/output devices can be separate from the computing device 1600 and can interact with one or more nodes of the computing device 1600 through a wired or wireless connection, such as over network interface 1640.

Those skilled in the art will appreciate that the computing device 1600 is merely illustrative and is not intended to limit the scope of embodiments. In particular, the computer system and devices can include any combination of hardware or software that can perform the indicated functions of various embodiments, including computers, network devices, Internet appliances, PDAs, wireless phones, pagers, and the like. The computing device 1600 can also be connected to other devices that are not illustrated, or instead can operate as a stand-alone system. In addition, the functionality provided by the illustrated components can in some embodiments be combined in fewer components or distributed in additional components. Similarly, in some embodiments, the functionality of some of the illustrated components may not be provided and/or other additional functionality can be available.

The computing device 1600 can communicate with other computing devices based on various computer communication protocols such a Wi-Fi, Bluetooth® (and/or other standards for exchanging data over short distances includes protocols using short-wavelength radio transmissions), USB, Ethernet, cellular, an ultrasonic local area communication protocol, etc. The computing device 600 can further include a web browser.

Although the computing device 1600 is depicted as a general purpose computer, the computing device 1600 is programmed to perform various specialized control functions and is configured to act as a specialized, specific computer in accordance with the present principles, and embodiments can be implemented in hardware, for example, as an application specified integrated circuit (ASIC). As such, the process steps described herein are intended to be broadly interpreted as being equivalently performed by software, hardware, or a combination thereof.

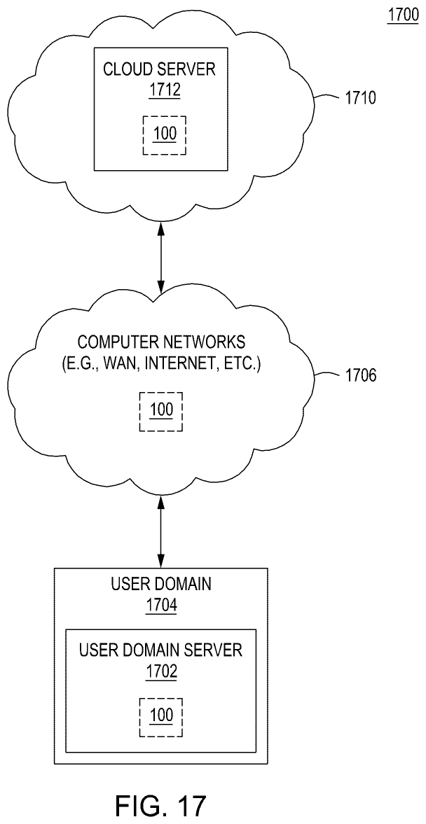

FIG. 17 depicts a high-level block diagram of a network in which embodiments of a data generation and training system in accordance with the present principles, such as the data generation and training system 100 of FIG. 1, can be applied. The network environment 1700 of FIG. 17 illustratively comprises a user domain 1702 including a user domain server/computing device 1704. The network environment 1700 of FIG. 17 further comprises computer networks 1706, and a cloud environment 1710 including a cloud server/computing device 1712.

In the network environment 1700 of FIG. 17, a system for data generation and training in accordance with the present principles, such as the system 100 of FIG. 1, can be included in at least one of the user domain server/computing device 1704, the computer networks 1706, and the cloud server/computing device 1712. That is, in some embodiments, a user can use a local server/computing device (e.g., the user domain server/computing device 1704) to provide data generation and training in accordance with the present principles.

In some embodiments, a user can implement a system for data generation and training in the computer networks 1706 to provide data generation and finetuning of a language model in accordance with the present principles. Alternatively or in addition, in some embodiments, a user can implement a system for data generation and training in the cloud server/computing device 1712 of the cloud environment 1710 to provide data generation and finetuning of a language model in accordance with the present principles. For example, in some embodiments it can be advantageous to perform processing functions of the present principles in the cloud environment 1710 to take advantage of the processing capabilities and storage capabilities of the cloud environment 1710. In some embodiments in accordance with the present principles, a system for providing data generation and training can be located in a single and/or multiple locations/servers/computers to perform all or portions of the herein described functionalities of a system in accordance with the present principles. For example, in some embodiments some components of a data generation and training system of the present principles can be located in one or more than one of the a user domain 1702, the computer network environment 1706, and the cloud environment 1710 while other components of the present principles can be located in at least one of the user domain 1702, the computer network environment 1706, and the cloud environment 1710 for providing the functions described above either locally or remotely.

Those skilled in the art will also appreciate that, while various items are illustrated as being stored in memory or on storage while being used, these items or portions of them can be transferred between memory and other storage devices for purposes of memory management and data integrity. Alternatively, in other embodiments some or all of the software components can execute in memory on another device and communicate with the illustrated computer system via inter-computer communication. Some or all of the system components or data structures can also be stored (e.g., as instructions or structured data) on a computer-accessible medium or a portable article to be read by an appropriate drive, various examples of which are described above. In some embodiments, instructions stored on a computer-accessible medium separate from the computing device 1600 can be transmitted to the computing device 1600 via transmission media or signals such as electrical, electromagnetic, or digital signals, conveyed via a communication medium such as a network and/or a wireless link. Various embodiments can further include receiving, sending or storing instructions and/or data implemented in accordance with the foregoing description upon a computer-accessible medium or via a communication medium. In general, a computer-accessible medium can include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods and processes described herein may be implemented in software, hardware, or a combination thereof, in different embodiments. In addition, the order of methods can be changed, and various elements can be added, reordered, combined, omitted or otherwise modified. All examples described herein are presented in a non-limiting manner. Various modifications and changes can be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances can be provided for components described herein as a single instance. Boundaries between various components, operations and data stores are somewhat arbitrary, and particular operations are illustrated in the context of specific illustrative configurations. Other allocations of functionality are envisioned and can fall within the scope of claims that follow. Structures and functionality presented as discrete components in the example configurations can be implemented as a combined structure or component. These and other variations, modifications, additions, and improvements can fall within the scope of embodiments as defined in the claims that follow.

In the foregoing description, numerous specific details, examples, and scenarios are set forth in order to provide a more thorough understanding of the present disclosure. It will be appreciated, however, that embodiments of the disclosure can be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” etc., indicate that the embodiment described can include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Embodiments in accordance with the disclosure can be implemented in hardware, firmware, software, or any combination thereof. Embodiments can also be implemented as instructions stored using one or more machine-readable media, which may be read and executed by one or more processors. A machine-readable medium can include any mechanism for storing or transmitting information in a form readable by a machine (e.g., a computing device or a “virtual machine” running on one or more computing devices). For example, a machine-readable medium can include any suitable form of volatile or non-volatile memory.

Modules, data structures, and the like defined herein are defined as such for ease of discussion and are not intended to imply that any specific implementation details are required. For example, any of the described modules and/or data structures can be combined or divided into sub-modules, sub-processes or other units of computer code or data as can be required by a particular design or implementation.

In the drawings, specific arrangements or orderings of schematic elements can be shown for ease of description. However, the specific ordering or arrangement of such elements is not meant to imply that a particular order or sequence of processing, or separation of processes, is required in all embodiments. In general, schematic elements used to represent instruction blocks or modules can be implemented using any suitable form of machine-readable instruction, and each such instruction can be implemented using any suitable programming language, library, application-programming interface (API), and/or other software development tools or frameworks. Similarly, schematic elements used to represent data or information can be implemented using any suitable electronic arrangement or data structure. Further, some connections, relationships or associations between elements can be simplified or not shown in the drawings so as not to obscure the disclosure.

This disclosure is to be considered as exemplary and not restrictive in character, and all changes and modifications that come within the guidelines of the disclosure are desired to be protected.

1. A method for determining question-answer pairs and finetuning a language model, comprising:
for at least two layers of a hierarchical taxonomy having at least two layers including respective words resulting in layers of varying complexity:
determining a set of words associated with a layer of the hierarchical taxonomy; and
determining at least one question-answer pair intended to increase a semantic understanding of content based on a question generated using at least one word of the set of words and the content to which the question-answer pair is applied; and
finetuning the language model using the determined question-answer pairs.

2. The method of claim 1, wherein the at least one question-answer pair intended to increase the semantic understanding of the content identifies a relationship among the components of the content.

3. The method of claim 2, wherein the components of the content include at least one of text content, image content, or a combination of text and image content.

4. The method of claim 1, wherein the finetuning of the language model increases the language model's semantic understanding of the content.

5. The method of claim 1, wherein generating the at least one question answer pair further comprises:
determining at least one stem question for a word of the set of words; and
determining at least one respective domain adapted question for at least one stem question based on at least one content domain;
wherein the at least one respective domain adapted question is used to generate the at least one question-answer pair.

6. The method of claim 1, further comprising:
for each determined question-answer pair:
determining a vector representation for the at least one question-answer pair and for content related to the at least one content domain of the at least one question-answer pair; and
embedding the vector representation determined for the at least one question-answer pair and the vector representation determined for the content related to the content domain into a common embedding space such that embedded vector representations for question-answer pairs and embedded vector representations for content related to the content domain that are related, are closer together in the common embedding space than unrelated embedded vector representations;
wherein the common embedding space comprises embedded question-answer pairs for each of the at least two layers of the hierarchical taxonomy, such that a relationship between embedded-question-answer pairs of varying complexity can be determined.

7. The method of claim 1, further comprising determining a content model for at least one of (i) each of the determined questions answer pairs in each of the at least two layers of the hierarchical taxonomy or (ii) for all of the question-answer pairs determined for the hierarchical taxonomy, collectively.

8. The method of claim 7, further comprising adapting a determined content model to apply to content not directly represented by the content model.

9. The method of claim 8, further comprising finetuning the language model using at least one of the content model or the adapted content model.

10. An apparatus for determining question-answer pairs and finetuning a language model, comprising:
a processor; and
a memory coupled to the processor, the memory having stored therein at least one of programs or instructions executable by the processor to configure the apparatus to:
for at least two layers of a hierarchical taxonomy having at least two layers including respective words resulting in layers of varying complexity:
determine a set of words associated with a layer of the hierarchical taxonomy; and
determine at least one question-answer pair intended to increase a semantic understanding of content based on a question generated using at least one word of the set of words and the content to which the question-answer pair is applied; and
finetune the language model using the determined question-answer pairs.

11. The apparatus of claim 10, wherein the at least one question-answer pair intended to increase the semantic understanding of the content identifies a relationship among the components of the content.

12. The apparatus of claim 11, wherein the components of the content include at least text content, image content, or a combination of text and image content.

13. The apparatus of claim 10, wherein the apparatus is further configured to:
determining at least one stem question for a word of the set of words; and
determining at least one respective domain adapted question for at least one stem question based on at least one content domain;
wherein the at least one respective domain adapted question is used to generate the at least one question-answer pair.

14. The apparatus of claim 10, wherein the apparatus is further configured to:
for each determined question-answer pair:
determine a vector representation for the at least one question-answer pair and for content related to the at least one content domain of the at least one question-answer pair; and
embed the vector representation determined for the at least one question-answer pair and the vector representation determined for the content related to the content domain into a common embedding space such that embedded vector representations for question-answer pairs and embedded vector representations for content related to the content domain that are related, are closer together in the common embedding space than unrelated embedded vector representations;
wherein the common embedding space comprises embedded question-answer pairs for each of the at least two layers of the hierarchical taxonomy, such that a relationship between embedded-question-answer pairs of varying complexity can be determined.

15. A system for determining question-answer pairs and finetuning a language model, comprising:
a language model; and
an apparatus comprising a processor and a memory coupled to the processor, the memory having stored therein at least one of programs or instructions executable by the processor to configure the system to:
for at least two layers of a hierarchical taxonomy having at least two layers including respective words resulting in layers of varying complexity:
determine a set of words associated with a layer of the hierarchical taxonomy; and
determine at least one question-answer pair intended to increase a semantic understanding of content based on a question generated using at least one word of the set of words and the content to which the question-answer pair is applied; and
finetune the language model using the determined question-answer pairs.

16. The system of claim 15, wherein the at least one question-answer pair intended to increase the semantic understanding of the content identifies a relationship among the components of the content.

17. The system of claim 15, wherein the components of the content include at least one of text content, image content, or a combination of text and image content.

18. The system of claim 15, wherein the finetuning of the language model increases the language model's semantic understanding of the content, which reduces hallucinations of the language model.

19. The system of claim 15, wherein the apparatus is configured to:
determine at least one stem question for a word of the set of words; and
determine at least one respective domain adapted question for at least one stem question based on at least one content domain;
wherein the at least one respective domain adapted question is used to generate the at least one question-answer pair.

20. The system of claim 15, wherein the language model comprises a large language model.
